(19) United States
(12) Patent Application Publication
(10) Pub. No.: US 2006/0022413 A1
(43) Pub. Date: Feb. 2, 2006

(54) Slide ring packing

(75) Inventor: Hans-Henning Zutz, Wermelskirchen (DE)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(73) Assignee: Federal Mogul Friedberg GmbH

(21) Appl. No.: 11/193,678

(22) Filed: Jul. 29, 2005

(30) Foreign Application Priority Data
Jul. 30, 2004 (DE) 10 2004 036 974.7

(51) Int. Cl. F16J 15/34

(52) U.S. Cl. 277/370

(57) ABSTRACT

Slide ring packing, especially running gear packing, comprising a countering and a slide ring, each with a gripping surface to receive an elastomer elastic body, a housing for the countering and slide ring with a counter gripping surface for the elastic body, whereby the housing lie inside one another, and are joined to form an installation unit and an anti-rotation element is provided in the area of the countering and the slide ring.

This invention claims priority to German Patent Application No. 10 2004 036 74.7, filed Jul. 30, 2004.

### BACKGROUND OF THE INVENTION

1. Technical Field

The invention describes a slide ring packing, namely a running gear packing according to the type-identifying part of the first patent claim.

2. Related Art

A slide ring packing is taken from DE-A 195 02 466, consisting of a slide and counterring, each having a gripping surface to receive an o-ring. The parts are held together by a connecting body so that they cannot be lost. The axial securing is effected by radially oriented projections.

A slide ring packing for machine parts that rotate relative to each other has become known through DE-U 7925908, comprising a slide ring that can be pressed against a counterring in a sealable manner by means of an axially elastic body and, in the area of a circumferential surface of the rings, a connecting body extending through radial deflections on both sides that holds the rings to a single installation unit. At least one of the radial deflections consists of several segments distributed around the circumference of the connecting body, which at need can be formed from outwardly bent flanges or knob-shaped bumps.

Track wheels and guide wheels of chain drives, such are used, for example, in grading and loading machines, are usually sealed with running gear seals.

A slide ring packing of this type that can be used as a running gear seal is described in U.S. Pat. No. 4,216,972. The same contains an installation unit in the form of a magazine. Slide ring and counterring function together with trapezoid-shaped elastic bodies, which are clamped between the gripping and counter gripping surfaces on the one hand and the respective housing on the other. In actual daily use it can happen that the slide ring slips through the counterring, whereby the elastomer part can be damaged, which reduces the service life of the slide ring packing.

### SUMMARY OF THE INVENTION AND ADVANTAGES

An object of the invention is to further develop a magazine seal on the basis of a running gear seal so that a considerably higher service life compared to the prior art can be reached.

This object can be accomplished by providing for an anti-rotation element in the area of the counterring and slide rings.

An object of invention provides for a magazine-like running gear seal that attains a longer service life compared to the prior art, as damage to the contact surfaces and elastomer parts no longer occurs.

On the basis of the chosen contours of both housings—similar to those described in U.S. Pat. No. 4,216,972—a slide ring packing that is easy to handle (and transport) has been made available.

A housing is employed that is approximately U-shaped in cross-section, whose axial sides are of different lengths and a housing that is approximately L-shaped in cross-section, whereby the radial and/or axial sides of both housings are used on the one hand to form the anti-rotation elements with the accompanying slide ring or counterring and on the other hand to form the magazine.

The slide and/or counterring are preferably made out of Duronite or Siculite.

The elastomer elastic body can be constructed using an o-ring as well as a trapezoidal washer. According to the range of application, inside a magazine too, an o-ring as well as a trapezoidal washer can be used. The chosen design has the advantage that the wear surfaces of the slide ring and counterring can be widened radially, whereby an even longer service life can be attained.

By using a trapezoidal washer as the elastomer elastic body, an exceptional quality arises such that if the receiving housing is suitably designed, the trapezoidal washer can be vulcanized onto the sheet-metal housing. The positive locking of the anti-rotation element results from the fitted extensions on the elastomer trapezoidal washer, which engage with corresponding grooves on the assigned slide ring or counterring.

The assembly of the magazine occurs through inserting the slide ring or counterring with its elastomer elastic body in the assigned housing part, whereby the anti-rotation element is mounted correspondingly. Afterwards the counterring or slide ring is inserted in its housing with the anti-rotation element, and the paired construction unit inserted into the housing of the first ring. Thereby the elastomer elastic body of the first ring deforms according to the calculated specifications to produce locking pressure. The parts are somewhat pressurized axially and the magazine can be locked to one of the axial sides with appropriate flanging. When the tension is released, the housing parts and the flange lie against each other, whereby the initial stress of the seals is preserved and the parts are centered. Furthermore, this enclosed state of material at time of supply effectively prevents fouling of the seal and damage to the sealing surfaces through improper handling.

The sheet-metal housing parts of the magazine can, as occasion demands, either be drawn only to the right size for a tight press fit or additionally sealed by applying sealing primer. As a further possibility, the housings can be constructed leak-proof and rotation-proof by vulcanizing on an elastomer material.

### THE DRAWINGS

The object of invention is depicted in the drawing as an embodiment and described as follows.

FIGS. 1 through 5 show: Various developments of the slide ring packing according to the invention.

### DETAILED DESCRIPTION

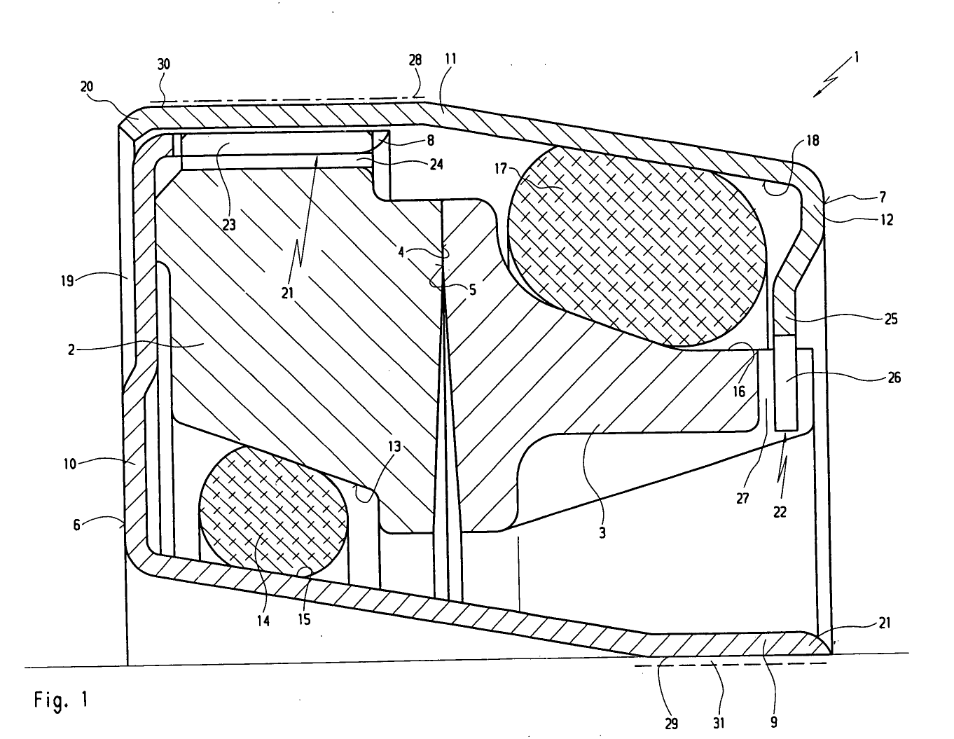

FIGS. 1 through 5 show various constructions of the object of invention. For that reason, the same parts are provided with the same reference symbol.

The slide ring packing 1 consists of the following parts: A stationary counterring 2, a rotatable slide ring 3, whereby in this example slide ring 3 and counterring 2 are composed of Duronite and reveal different cross sections. The sliding surfaces 4, 5 of counterring 2 and slide ring 3 are designed relatively wide radially whereby a long service life can be attained. In this example, counterring 2 is assigned a housing 6 somewhat U-shaped in cross section, while slide ring 3 is at least partially enclosed by a housing 7 designed to have a somewhat L-shaped cross section. The U-shaped housing 6 contains a shorter axial side 8 and a longer axial side 9, which are joined together by a radial side 10. The L-shaped housing 7, positioned inside the radial/axial boundary edge of U-shaped housing 6, contains an axial side 11 and a radial side 12. Both housings 6, 7 consist of sheet-metal and are designed as deep drawing parts. Counterring 2 has a conical gripping surface 13, serving to receive an elastomer elastic body 14, which is propped on the housing side against a conical counter gripping surface 15. Slide ring 3 also has a conically constructed gripping surface 16, which serves to receive an elastomer elastic body 17, which, on the housing side, is propped against a provided conical counter gripping surface 18.

The respective elastomer elastic bodies 14, 17 can, if required, be constructed using an o-ring and/or a trapezoidal washer, which is documented in the various Figures. The radial side 10 of housing 6 has a circumferential stamping area 19. The axial side 11 of housing 7 is flanged at its free end 20 and engages the stamping area 19 of the radial side 10 in such a way that the axial boundary edge is not exceeded. The axial side 9 is constructed of such a length that its free end 21 does not jut out over the axial boundary edge of the radial side 12 of housing 7. With these measures an easy to carry and simple to mount magazine-like slide ring packing (running gear seal) is constructed, that, as already addressed, can serve as a replacement for the bis dato employed RWDR magazines. In the region of counterring 2, as well as slide ring 3, anti-rotation elements 21, 22 are provided according to the invention, which are variously constructed.

FIG. 1 shows an anti-rotation element 21 in which the shorter axial side 8 of the U-shaped housing 6 is provided with tongues 23 that engage with corresponding recesses 24 on counterring 2. At anti-rotation element 22 the radial side 12 of housing 7 is provided with an angular area 25, which also contains tongues 26 which engage with corresponding recesses 27 on slide ring 3. The outer peripheral area 28 of housing 7 as well as the inner peripheral area 29 of housing 6 are each at least partially provided with a coating of sealing primer 30, 31, whereby additional sealing is attained. In this Figure two elastomer elastic bodies 14, 17 designed as o-rings are being employed.

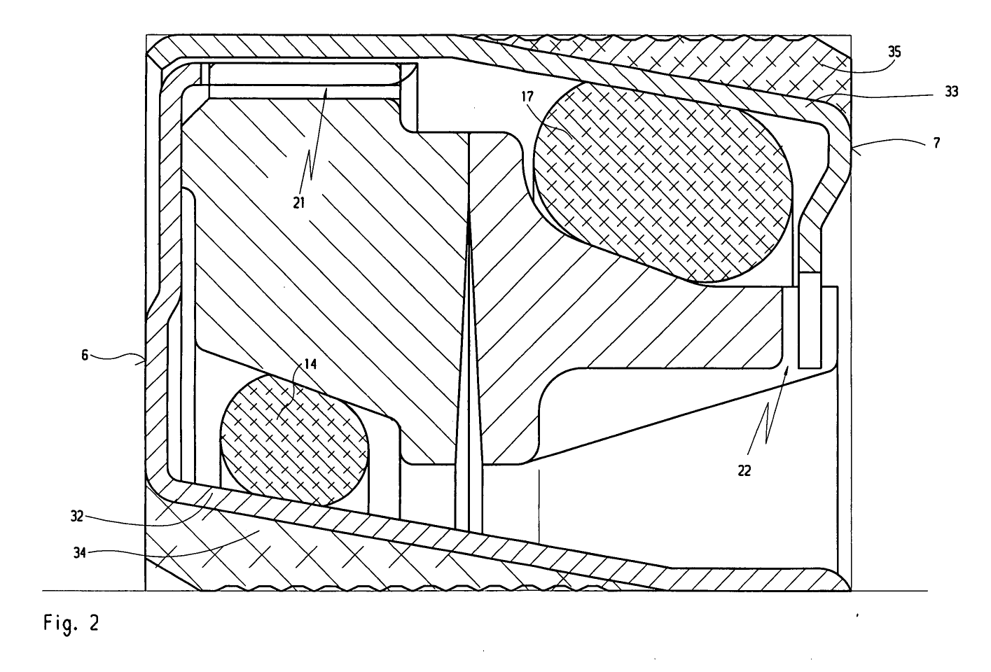

The difference between FIG. 2 and FIG. 1 lies in the fact that, instead of a coating of sealing primer in the recessed partial area 32, 33 of housings 6, 7, elastomer material 34, 35 is vulcanized on. Here too, two o-rings 14, 17 are employed and also the anti-rotation elements 21, 22 are constructed in the same way as shown in FIG. 1.

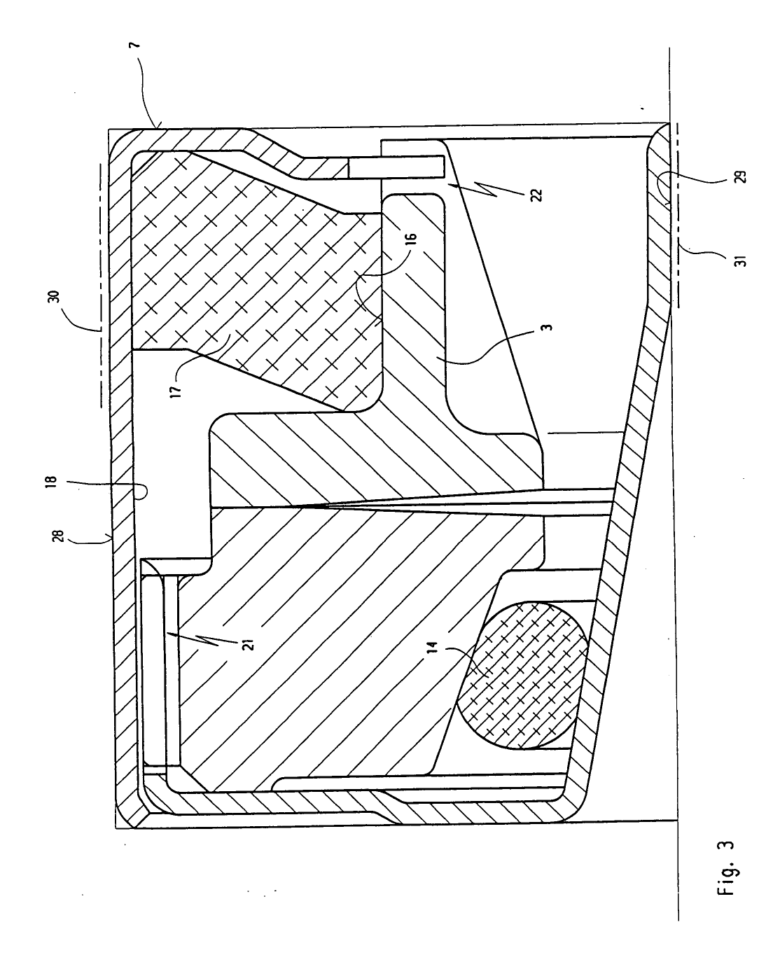

The slide ring packing 1 according to FIG. 3 shows that slide ring 3 is in operative connection with a trapezoidal shaped elastomer elastic body 17. In this example, the gripping surface 16 of slide ring 3 is not conical but rather cylindrical. The same is true of the counter gripping surface 18 of housing 7. The outer/inner peripheral area 28, 29 of housings 6, 7 is at least partially coated with a layer of sealing primer 30, 31. The anti-rotation elements 21, 22 are planned to be analogous to FIGS. I and 2.

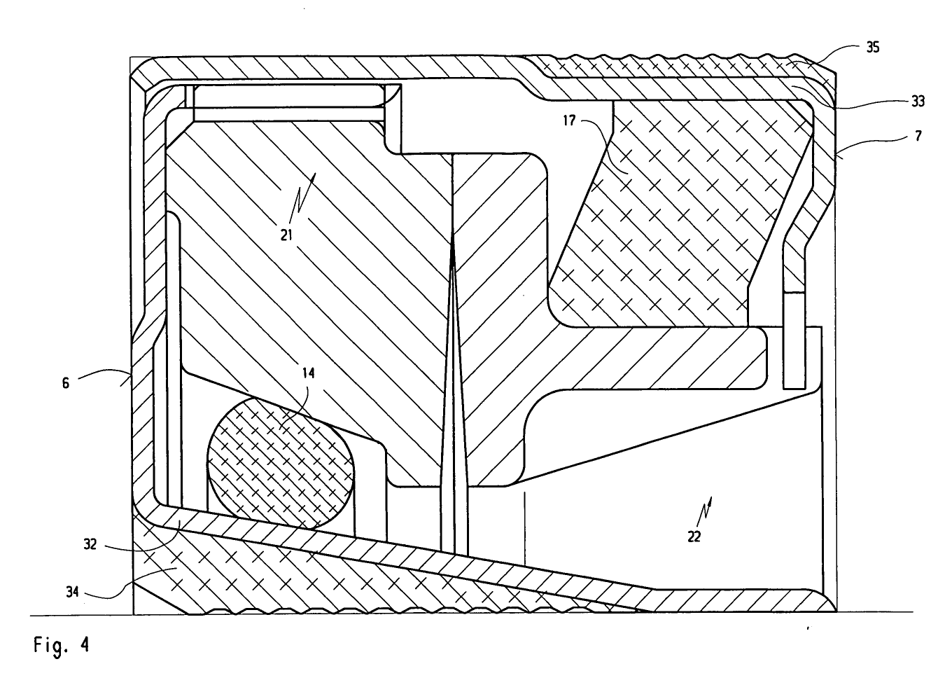

FIG. 4 shows a variant similar to FIG. 3. Here too a trapezoidal washer 17 is employed as an elastomer elastic body. Similar to the situation shown in FIG. 2, the recessed partial area 32, 33 of the housing 6, 7 is provided with a vulcanized elastomer layer 34,35. The anti-rotation element 21, 22 is made effective as shown in FIG. 3.

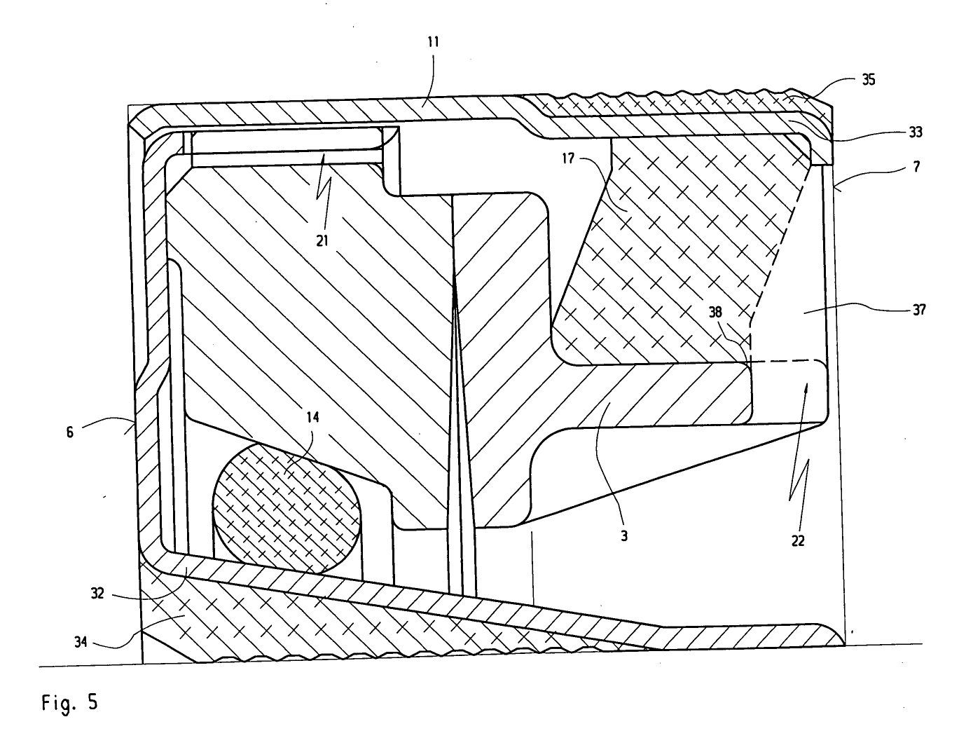

FIG. 5 shows a further alternative to FIGS. 3 and 4. Here too a trapezoidal washer 17 is employed as an elastomer elastic body. In this example, the inner peripheral area 36 facing the axial side 11, respectively the recessed partial area 33 serves to allow the trapezoidal washer 17 to be vulcanized on the one hand to the interior circumferential area 36 and on the other to the radial side 12 of the housing 7. The anti-rotation element 21 is constructed as already described in the previous Figures. In this example, the anti-rotation element 22 is made effective by the fact that on the trapezoidal washer 17 extensions 37 are formed that engage with corresponding grooves 38 on the slide ring 3. Analogous to FIG. 4, the recessed partial areas 32, 33 of the housings 6,7 are provided with a vulcanized elastomer layer 34, 35.

In the slide ring packings 1 depicted in FIGS. 1 through 5, the counterrings 2 are sealed statically against the housing using o-rings14. Via the conically shaped gripping surface 13/counter gripping surface 15 larger radial tolerances can be spanned. Advantageously, the gripping surface 13 of counterring 2 need not be machined. The seal side D, which is exposed to dirt, is closed to the greatest possible extent, while the seal side S, which faces the lubricant, is wide open. The assembly of the slide ring packing 1 designed as a magazine occurs via the insertion of the slide ring 3 with its elastomer elastic body 17 into the L-shaped housing 7, whereby the anti-rotation element 22 is mounted correspondingly. Then the counterring 2 is put in its U-shaped housing 6 together with the anti-rotation element 21 and this paired construction unit introduced into the housing 7 of the slide ring. Therby the elastic body 17 deforms according to the calculated specifications to produce locking pressure. The housings 6, 7 are somewhat pressurized axially and the magazine can be locked with appropriate flanging 20. When the tension is released, the housing parts 10, 20 in the stamping area 19 lie against each other, whereby the initial stress of slide ring 3 and counterring 2 is preserved. In this enclosed state of material at time of supply, the sliding surfaces 4, 5 of the slide ring packing 1 are effectively protected against fouling and damage as well as against improper handling.

The slide ring packings 1 represented in FIGS. 1 through 5 represent merely examples, whereby depending on the application, a different housing arrangement as regards the configuration of the slide ring and counterring as well as the interacting elastic body 14, 17 can be chosen, without leaving the zone of protection.

What is claimed is:

1. Slide ring packing, comprising a counterring and a slide ring each with a gripping surface to receive a corresponding elastomer elastic body, a housing for each of the countering and slide ring with a counter gripping surface on each housing for the elastomer bodies, said housings structure lying inside one another and joined to form an installation unit and anti-rotation structure provided in the area of the counterring and slide ring.

2. Slide ring packing according to claim 1, wherein one of said housings is approximately U-shaped in cross section and the other of said housings is approximately L-shaped, and that at least one part of an axial side away from the counter gripping surface of said U-shaped housing engages with at least one provided recess in the associated counterring or slide ring.

3. Slide ring packing according to claim 2, wherein in said L-shaped housing at least one part of a radial side engages at least one provided recess in the associated counterring or slide ring.

4. Slide ring packing according to claim 1, including a trapezoidal washer as an elastomer spring element vulcanized to an opposite peripheral area of the associated housing and having projections that engage with corresponding grooves of the assigned slide ring or counterring.

5. Slide ring packing according to claim 1, wherein the housings include axial sides, at least one of which is at least partly coated with a sealing primer in a peripheral area thereof.

6. Slide ring packing according to claim 1, wherein the housings include axial sides, at least one of which includes a recessed area at least partially coated with an elastomer layer.
